(19) United States
(12) Patent Application Publication
(10) Pub. No.: US 2002/0165644 A1
(43) Pub. Date: Nov. 7, 2002

(54) Method of preventing damage on machine tools and production machines, and also robots

(76) Inventor: Werner Agne, Rothenbach (DE)

Correspondence Address: BAKER & BOTTS, 30 ROCKEFELLER PLAZA, NEW YORK, NY, 10112

(21) Appl. No.: 09/925,054

(22) Filed: Aug. 8, 2001

(30) Foreign Application Priority Data
May 2, 2001 (DE) 101 213 23.9

(51) Int. Cl. G05D 3/12

(52) U.S. Cl. 700/293

(57) ABSTRACT

The invention relates to a method of preventing damage to machine tools, production machines, and robots, wherein an electrical power supply system (V) is monitored by a system monitor (N) for the presence and maintenance of a required quality of power and detection of unwanted system states which are transmitted in real time so as to cause the initiation of a drive braking function and/or a system standstill by drive controllers (AR1 to AR6).

### FIELD OF THE INVENTION

The invention relates to a method of preventing damage on machine tools production machines, and robots.

### BACKGROUND OF THE INVENTION

EP 0 687 395 B1 discloses a method of preventing damage on numerically controlled machines in the event of a power failure. There it is disclosed how, in the event of a power failure, the supply voltage for at least one axis drive motor is obtained from the kinetic energy of at least one other axis drive motor, with the result that a position-controlled, programmed emergency return traverse takes place.

EP 0 583 487 B1 discloses a method of braking the axis drives of numerically controlled machines optimally in terms of time and without deviating from their path. In these machines, emergency braking of the axis drives is provided for hazardous situations. If this emergency braking is triggered, the drives of the numerically controlled machine brake linearly in the shortest time with the nominal rotational speed values being correspondingly prescribed. With time-optimal, path-maintaining braking it is intended to avoid collision of the tool with the workpiece or other objects in a deviation from the intended path.

A rotary printing machine is described in WO 97/11848. This generally comprises a plurality of rotary presses which can operate simultaneously and independently of one another. Each rotary press comprises, inter alia, roll carriers for the paper rolls, draw rollers for drawing the paper web in and out at the printing towers, printing stations, which operate in combination as U, Y or H printing units in one or more printing towers, auxiliary drives at the printing stations and the folder.

If a failure occurs in the power supply to machine tools, production machines, and robots, (machines) unforeseeable machine states may occur until the system is brought to a standstill. These machine states may damage a product being processed and also damage the machine itself. Under certain circumstances, such damage may result in costly repairs, long shutdowns of the system, and time expended on setting up the machines for a controlled production start-up.

### SUMMARY OF THE INVENTION

The object of the present invention is to monitor the maintenance of a required quality of power from a power supply system for a machine in order to sense unwanted system states in real time, and initiate a drive braking function which brings about a system standstill without any damage or, if unavoidable, with minimal damage. According to the present invention, this object is achieved by:

monitoring an electrical power supply system for the presence and maintenance of a required quality of power by a system monitor;

transmitting an unwanted system state in real time to a drive controller with master functionality; and

initiating a drive braking function and/or effecting a system standstill.

The real-time transmission of a faulty state means that the system is prepared to effect a system standstill from the time the fault is detected. The drive controllers usually have an energy store, so that an unwanted system state does not have immediate effects on the system functionality. Even before this energy store has been depleted, the system can be brought to a system standstill, i.e. a system standstill. Since this takes place in a controlled manner, i.e. the system standstill is completed in a time period in which the system is still supplied with power, system and product defects can be kept to a minimum or avoided completely. As a consequence, extremely short system downtimes can be achieved, provided that a power supply is readily available. Consequently, any financial loss is expected to be low, since damage and downtime are minimized.

In a preferred method of the present invention at least two individual drives can be synchronized with one another and a synchronized drive braking function (and/or a system standstill) is initiated by detection of an unwanted system state. By this method, uncontrolled idling of drives which can be synchronized with one another is avoided. In particular if individual drives operate in a way in which they are synchronized with one another, it is also necessary, if so required, to bring them to a system standstill in a controlled manner to avoid damage to machines and products.

In a further preferred method of the present invention a real-time Ethernet is used for the transmission of an unwanted system state. Consequently, the methods according to the invention can be employed using a universal and standardized bus protocol with a high transmission capacity.

Yet a further preferred method of the present invention is where an unwanted system state is transmitted in real time to a drive controller with master functionality and this information is provided in other drive groups via a real-time cross communication. By this method it is ensured that, when a system fault is transmitted from the system monitor to only one drive controller with master functionality, other drive groups are also notified of the forthcoming event in real time. A synchronized drive braking function and/or a synchronized system standstill can also be brought about via the real-time cross communication.

An advantageous application of the present invention is obtained in a machine tool, or production machine, or robot having at least two synchronizable individual drives of rotating machine elements and at least one real-time data communication system.

A further advantageous application of the invention is obtained in a printing machine with at least two synchronizable individual drives of rotating machine elements and at least one real-time data communication system.

### DRAWINGS

A preferred embodiment of the present invention is described in more detail below and in the context of the drawing, in which:

FIG. 1 shows a block diagram of interlinked drives, which are connected to a common power supply with a system monitor.

### DETAILED DESCRIPTION OF THE INVENTION

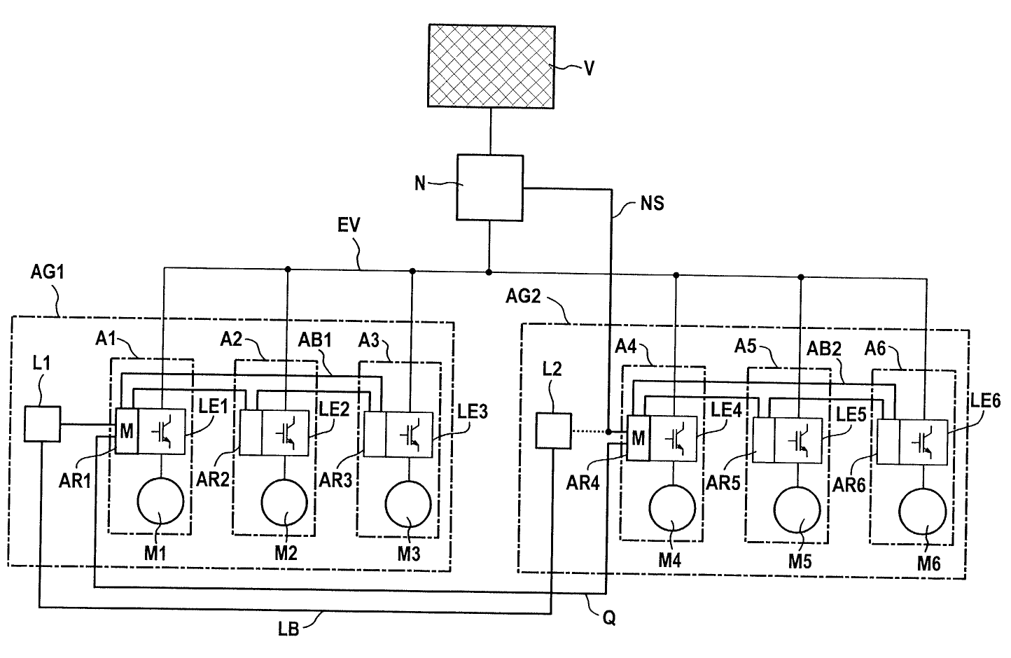

In FIG. 1, the major components of a drive A1 to A6 are depicted in a rectangle with a broken outline. The drive comprises at least one motor M1 to M6, which is activated by a drive controller AR1 to AR6 via power electronics LE1 to LE6. This is identified by a symbol from power electronics, namely an IGBT circuit symbol.

The drive controllers AR1 to AR6 of a respective drive group AG1, AG2 are interlinked with one another in the form of a ring. Further networking structures, feasible in terms of data technology, are also conceivable for the drive controllers AR1 to AR6. In each case, one drive controller AR1 to AR6 of a drive group AG1, AG2 has master functionality AR1, AR4. This is identified in FIG. 1 by a letter M and a more pronounced outline. The data network AB1, AB2 close to the drive undertakes the synchronization of the drives A1 to A6 of a drive group AG1, AG2. A cross communication Q makes it possible for the drive controllers with master functionality AR1, AR4 to exchange data close to the drive, which are necessary for the mutual coordination of open-loop or closed-loop control actions. The drives A1 to A6 of a drive group AG1, AG2 are identified by a rectangle with a broken outline.

For each drive controller with master functionality AR1, AR4, there is a master computer L1, L2, which performs a function with higher-level control over the drives. The master computers L1, L2 are connected to a master computer bus LB and can, for example, collect, exchange, evaluate and display process data (human-machine interface). All the data connections Q, LB, AB 1, AB2, NS can, if so required, be executed by a real-time data network, such as a real-time Ethernet.

The power electronics LE1 to LE6 of the drives A1 to A6 are connected to the power supply system V with the aid of a power distributor EV and a system monitor N. In this case, a system monitor N senses the presence and maintenance of required limits for power quality. If a system failure of the power supply system V occurs, or if the required quality of power is not maintained, a signal is transmitted to the drive controllers with master functionality AR1, AR4. If a rapid response to this state is required, it is advisable to install a real-time data link.

Information from the system monitor N can be made available to various components of the drives, and also higher-level institutions. All feasible data link structures are conceivable, such as a serial, an annular or a star-shaped link structure.

In FIG. 1, the system signal NS is made available to the drive controller with master functionality AR4. An optional link to the master computer L2 is depicted by broken lines. The drive controller with master functionality AR4 can notify other drive groups AG1, AG2 of this information with the aid of the cross communication Q.

If an unwanted system state occurs, all the drives A1 to A6 can immediately initiate a drive braking function and/or a system standstill, possibly synchronized by a drive controller with master functionality AR1, AR4. The synchronization of the drives AR1 to AR6 during a drive braking function avoids or minimizes damage to the product, and also to parts of the system itself. If, for example, a printing machine is brought to a system standstill on the basis of information of the system monitor N, the synchronization of the drives A1 to A6 ensures that a transported paper web does not tear. System damage due to a torn paper web is also avoided, for example, jamming of machine parts caused by bits of paper. The overall benefit that results is that the downtime of the printing machine can be significantly reduced.

If major data lines are equipped with real-time functionality, immediate response is possible and the information occurring in the course of a braking function can be made available throughout the system in real time. Even before the stored energy from the converters LE1 to LE6 of the drives A1 to A6 is used up, a system standstill can be brought about.

The use of a real-time Ethernet having at least one data link Q, LB, AB1, AB2, NS means that a standardized, widespread and universally usable bus protocol is used. This makes short bus cycles possible by its high transmission capacity. Consequently, system data which require a fast response, such as a correction of deviations from nominal values, can be advantageously made available in real time.

I claim:

1. A method of preventing damage in a machine comprising monitoring an electrical power supply system for the presence and maintenance of a required quality of power by a system monitor; transmitting an unwanted system state in real time to a drive controller having master functionality; and initiating a drive braking function and/or a system standstill by the drive controller.

2. The method according to claim 1, further comprising synchronizing at least two individual drives with each other, and synchronizing a drive braking function and/or a system standstill in response to an unwanted system state.

3. The method according to claim 1, further comprising using a real-time Ethernet for the transmission of an unwanted system state.

4. The method according to claim 1, further comprising transmitting an unwanted system state in real time to the drive controller and providing this information to drive groups via a real-time cross communication.

5. A machine comprising at least two synchronizable individual drives of rotating machine elements and at least one real-time data communication system, and further comprising a monitoring system for monitoring an electrical power supply system to said machine to ensure the presence and maintenance of a required quality of power and detection of an unwanted system state, wherein said real-time data communication system transmits the detection of an unwanted system state to a drive controller having master functionality, and braking or system standstill means.

6. A printing machine comprising the component according to claim 5, wherein the machine further comprising at least two synchronizable individual drives for rotating machine elements, and wherein the braking and/or system standstill means are synchronized in response to an unwanted system state, the data communication system is a real-time Ethernet, and a real-time cross communication system for communicating an unwanted system state to drive groups.
